(19) United States
(12) Patent Application Publication
(10) Pub. No.: US 2008/0057231 A1
(43) Pub. Date: Mar. 6, 2008

(54) Ink Jet Recording Sheet for Pigmented Ink

(76) Inventors: Jun Li, Lexington, KY (US); Yaqiang Frank Ming, Lexington, KY (US); Rebecca Silveston-Keith, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/426,600

(22) Filed: Jun. 27, 2006

(51) Int. Cl. B41M 5/00

(52) U.S. Cl. 428/32.18

(57) ABSTRACT

The present invention relates to ink-receiving print media products capable of improving smear for pigmented inks. The products have at least one ink-receiving layer supported by a substrate. The ink-receiving layer includes a binder blend and a pigment, for example, polyvinyl alcohol, styrene-acrylate copolymer, and silica. The print media product has excellent smear resistance when pigment-based ink is printed on the ink receiving layer of the substrate.

### TECHNICAL FIELD

The present invention relates to ink-receiving print media products capable of improving smear for pigmented inks.

### BACKGROUND OF THE INVENTION

Ink jet printing is a non-impact method of printing that involves ejecting ink from a nozzle onto paper or other print media. The actual ink ejection method may occur via several processes including pressurized nozzles, electrostatic fields, piezoelectric elements within an ink nozzle, and heaters for vapor phase bubble formation.

The composition of the ink is traditionally comprised of deionized water, a water soluble organic solvent, and a colorant. The colorant may be a soluble dye or insoluble pigment. Several problems, however, are associated with soluble dyes that are not applicable to insoluble pigments. These problems include poor water-fastness, poor light-fastness, poor thermal stability, facile oxidation, dye crystallization, and ink bleeding and feathering on the print medium. To circumvent these problems, use of a pigment as the colorant is preferred. Pigments generally have better light-fast and water-fast properties, are more resistant to oxidation, and have higher thermal stability.

Use of a pigment instead of an aqueous dye presents solubility problems since the pigments are insoluble in aqueous media. As a result, the insoluble pigment is generally stabilized in a dispersion by a polymeric dispersant.

Smear resistance on photo paper, especially on gelatin paper, is a significant problem for pigment-based inks. Most gelatin paper is designed for use with dye-based inks. When a pigment-based ink is printed onto a gelatin photo paper, the solvents will penetrate into the paper and later evaporate into the environment. Pigment and the polymeric dispersant will loosely pack on the paper surface. The packed pigment-dispersant cake has only a weak adhesion on the paper surface, and weak smear resistance has often been observed.

By changing ink or photo paper formulation, many methods have been disclosed in the past to improve smear resistance. For example, U.S. 20040102541 disclosed graft polymeric dispersants in pigment-based inks to increase smear resistance; U.S. 20050166794 disclosed using a dispersed cellulose ester as a binder additive in pigment-based inks to enhance the durability of the printed images; U.S. 20050134665 disclosed ink additives that contains benzyl methacrylate to increase smear resistance. U.S. 20050110856, U.S. Pat. No. 6,020,397, and U.S. Pat. No. 6,503,307 disclosed some imaging fixing components (reactive liquids) to improve abrasion resistance. On the other hand, U.S. Pat. Nos. 6,844,035, 6,689,433, and 6,528,148 disclosed the use of a poly (vinyl alcohol polyethylene oxide) copolymer and other binders in polymer-based photo papers to improve smear-fastness.

It is an objective of this invention to provide an ink jet recording sheet that has excellent smear resistance as pigmented ink is printed on. The ink-receiving layer includes a binder blend and a pigment designed to achieve the aforementioned goal, namely, polyvinyl alcohol, styrene-acrylate copolymer, and silica or alumina.

### SUMMARY OF THE INVENTION

The present invention provides ink-receiving print media products capable of improving smear for pigmented inks. The print media products have at least one ink-receiving layer supported by a substrate. The ink-receiving layer includes a binder blend and a pigment, namely, polyvinyl alcohol, styrene-acrylate copolymer, and a pigment comprised of silica or alumina or mixtures thereof. One or more optional binders and/or pigments can also be included within the ink-receiving layer. The ink-receiving layer may optionally be employed in combination with one or more additional layers over or under which can contain one or more pigments and/or binders. The ink-receiving layer of the substrate acts to improve the smear resistance of a pigment-based ink composition when printed on the ink receiving layer of the substrate.

The first binder in the ink receiving layer is comprised of polyvinyl alcohol (PVA). Polyvinyl alcohol as used herein includes partially, intermediately, and fully hydrolyzed. The ink-receiving layer is comprised of from about 3% to about 95% by weight of the first binder of polyvinyl alcohol.

The second binder in the ink receiving layer is comprised of an acrylate polymer. A preferred acrylate polymer includes styrene acrylate with acid functional group containing diene monomer. The polymer is typically made by emulsion polymerization and has high molecular weight. The high molecular weight gives good binding strength, the acid functional group gives good stability, interaction with coating pigment and absorption of ink water and solvents. The acrylate has good interaction with dispersants in the ink. The ink-receiving layer is comprised of from about 2% to about 85% by weight of the second binder of styrene acrylate.

The pigment in the ink-receiving layer is comprised of silica or alumina or mixtures thereof. The silica pigment in the ink receiving layer includes fumed, precipitated, colloidal, and silica gel. The fumed silica is preferred because it gives good porosity and gloss. Alumina pigments such as fumed alumina, alumina hydrate or boehmite can be used to replace silica partially or completely. The ink-receiving layer is comprised of from about 1% to about 95% by weight of the pigment.

In a preferred embodiment, the ink receiving layer comprises a pigment to binder ratio of from about 1 to about 15 of pigment to total binder.

In another preferred embodiment, the ink receiving layer comprises a first to second binder ratio of from about 0.1 to about 10.

In yet another preferred embodiment, the ink receiving layer has a coating thickness from about 5 μm to about 100 μm .

All percentages and ratios, used herein, are “by weight” unless otherwise specified. All molecular weights, used herein, are weight average molecular weights unless otherwise specified. Further details and advantages of the present invention are set forth below in the following more detailed description.

### DETAILED DESCRIPTION OF THE INVENTION

The present invention provides ink-receiving print media products capable of improving smear for pigmented inks. The print media products have at least one ink-receiving layer supported by a substrate. The ink-receiving layer includes a binder blend and a pigment, namely, polyvinyl alcohol, styrene-acrylate copolymer, and silica or alumina. One or more optional binders and/or pigments can also be included within the ink-receiving layer. The ink-receiving layer may optionally be employed in combination with one or more additional layers over or under which can contain one or more pigments and/or binders. The ink-receiving layer of the substrate acts to improve the smear resistance of a pigment-based ink composition when printed on the ink receiving layer of the substrate.

Smear resistance on photo paper, especially on gelatin paper, is a significant problem for pigmented inks comprising a pigment dispersion. Most gelatin paper is designed for use with dye based inks. When conventional pigmented inks are printed on gelatin based paper, the pigmented dispersion remains on the surface of the gelatin coating and is susceptible to smearing or smudging.

The invention, in one form thereof, is directed to a print media product having at least one ink-receiving layer supported by a substrate. The substrate employed may be any substrate compatible with the ink receiving layer, including, but not restricted to, synthetic or ligno cellulosic materials for example plain papers, such as commercial bond papers; coated papers such as those available from Hewlett Packard, Kodak, Ilford, Canon, and Xerox Corporation; film such as base material for inkjet transparency materials, and textiles.

In a preferred embodiment, the ink-receiving layer has a coating thickness from about 5 μm to about 100 μm. The coating thickness of the ink receiving layer is more preferably from about 5 μm to about 60 μm, most preferably from about 10 μm to about 40 μm.

The ink receiving layer can be used alone or one gloss and/or antiscratch improvement layer applied on top of it, or another ink receiving layer applied under it or both over and under the layer. Regarding the binder blend and pigment comprising the ink receiving layer, the following materials are considered to be preferred:

The first binder in the ink receiving layer is comprised of polyvinyl alcohol (PVA). Polyvinyl alcohol as used herein includes partially, intermediately, and fully hydrolyzed. It also includes cationic, anionic, and silanol, polyethylene oxide modified, etc. PVA can have a range of molecular weight from low to medium to high. The medium to high molecular weight and partially hydrolyzed is preferred, such as Mowiol 40-88. The advantage of PVA is its strong binding strength with pigment and good water and solvent absorption. The basic structural formula for polyvinyl alcohol is as follows:

(—CH₂CHOH—)ₓ

(wherein x=about 1-3000 in a representative, non-limiting, and preferred embodiment).

This material is commercially available from numerous sources including but not limited to Nippon Gohsei of Osaka, Japan under the product designation “GOHSENOL NH-26”, Dupont under the product designation “Elvanol 50-42”, as well as Clariant under the product designation of “Mowiol 40-88”. Exemplary and non-limiting derivatives of polyvinyl alcohol which shall be encompassed within the term “polyvinyl alcohol” as used herein include but are not limited to unsubstituted polyvinyl alcohol as illustrated and discussed above, carboxylated polyvinyl alcohol, sulfonated polyvinyl alcohol, acetoacetylated polyvinyl alcohol, and mixtures thereof.

However, regarding the use of polyvinyl alcohol as a binder composition “straight” (e.g. unsubstituted) polyvinyl alcohol is preferred. Likewise, use of the term “polyvinyl alcohol” as stated herein shall encompass polyvinyl alcohols which are “fully hydrolyzed” or “partially hydrolyzed. During the production process associated with polyvinyl alcohol varying degrees of “hydrolysis” can occur whereby, in certain situations, residual acetate groups (—OCOCH₃) are left within the polyvinyl alcohol backbone depending on a wide variety of production and reaction parameters. For example, a polyvinyl alcohol molecule is traditionally considered to be “fully hydrolyzed” if less than about 1.5 mole percent acetate groups are left on the molecule. This characterization is discussed in, for instance, U.S. Pat. No. 5,880,196.

In addition, “polyvinyl alcohol” shall also be defined and interpreted herein to encompass structures wherein the polyvinyl alcohol component thereof is considered to be “partially hydrolyzed”. Partially hydrolyzed polyvinyl alcohol is typically defined to involve polyvinyl alcohol molecules wherein about 1.5 to as much as about 20 mole percent or more acetate groups are left on the molecule. Again, the extent of hydrolysis will depend on a wide variety of production parameters. It has been determined that, while any of the aforementioned polyvinyl alcohol compositions within the foregoing broad definition can be used as a first binder material, polyvinyl alcohols having a hydrolysis level of about 80-98% will provide effective results.

The second binder in the ink receiving layer is comprised of an acrylate polymer. A preferred acrylate polymer includes styrene acrylate with acid functional group containing diene monomer. The polymer is typically made by emulsion polymerization and has high molecular weight. The high molecular weight gives good binding strength, the acid functional group gives good stability, interaction with coating pigment and absorption of ink water and solvents. The acrylate has good interaction with dispersants in the ink.

The preparation of styrene acrylate binder is well known to those skilled in the art. For example, the preparation of emulsion polymers is described in Emulsion Polymerization by Gilbert, R. G., Academic Press, N.Y., 1995. They can be made by a continuous process as described in U.S. Pat. Nos. 4,546,160, 4,414,370 and 4,529,787 all of which are incorporated herein by reference. They can also be made as resin-supported emulsions prepared by aqueous phase polymerization in the presence of water-dispersible support resins as described in U.S. Pat. Nos. 4,894,397, 4,839,413, and 4,820,762, all of which are incorporated herein by reference. Generally such polymers are prepared with ethylenically unsaturated monomers, initiators, and optionally with surfactants, alkali, and water or another reaction solvent. Exemplary monomers include, but are not limited to, acrylic acid, methacrylic acid, styrene, methyl styrene, butyl acrylate, ethyl methacrylate, 2-ethyl hexyl acrylate, methyl methacrylate etc. Those skilled in the art will readily appreciate that the mixture of monomers may be varied as necessary to tailor the polymer to the particular application. For example, the second binder can have a wide range of acid numbers from 20 to 350. The second binder also can have a wide range of glass transition temperatures from −30 to 150° C.

In a preferred embodiment, the styrene acrylate polymer is an emulsion and has a number molecular weight above 20,000, an acid number of from about 20 to about 350, and a Tg of from about −30° C. to about 150° C. In one embodiment of the present invention, a specific acrylic-based polymer emulsion, Joncryl 660 Film Form Emulsion from Johnson Polymer (Sturtevant, Wis.), was used as the second binder in the ink receiving layer. Some physical properties of Joncryl 660 are listed in Table 1 below.

TABLE 1

| | |
|---|---|
| pH | 8.5 |
| Non-Volatile | 32% |
| MW | >200,000 |
| Viscosity | 400 cps |
| Tg | 27° C. |
| Acid Number | 203 (NV) |

### Typical Physical Properties of Joncryl 660

The silica pigment in the ink-receiving layer includes fumed, precipitated, collodial, and silica gel. Cationic-modified silica (e.g. alumina-treated silica is an exemplary and non-limiting embodiment) and cationic polymeric binder-treated silica can also be used. The fumed silica is preferred because it gives good porosity and gloss. It should be understood that the use herein of the general term “silica” (which is likewise known as “silicon dioxide”) shall be interpreted to encompass any of the individual silica forms listed above alone or in any combination.

Other pigments: other pigments such as fumed alumina, alumina hydrate or boehmite can also be used to replace silica partially or completely.

Other binders: other binders such as PVP, PVA-PVP copolymer can also included but not necessary.

Crosslinkers: any standard crosslinker such as boric acid in the art can be added optionally.

Other additives known in the art can be added optionally, including: any surfactants for wetting, defoamers, biocides, hardeners, thickeners, UV/light stabilizers, buffers, slip agents, pH control compounds, and mixtures thereof.

The coating method used to apply the coating formulation to make the ink-receiving layer may be any appropriate manufacturing procedures including, without limitation, roll-coating, spray-coating, immersion coating, cast-coating, slot-die coating, curtain coating, rod-coating, blade-coating, roller application, and other related production methods.

Drying: any drying method in the art such as convection flow, IR etc can be used to dry the coatings.

It is also observed that the thickness, or ink capacity, of the ink-receiving layer can affect both the short-term and long-term smear resistance of pigment-based inks prints. The preferred thickness of the ink-receiving layer is from about 5 μm to about 60 μm depending on the substrate type. Non porous substrates will require higher ink capacities and hence thicker ink receiving layers. When the coating thickness is less than 5 μm, it is observed that the coating layer may not provide enough ink capacity and the ink smear resistance is low. On the other hand, when the ink receiving layer is greater than 60 um, the coating tends to have cracks which result in poor coating strength and poor ink smear resistance.

As discussed above, the ink-receiving layer of the substrate acts to improve the smear resistance of a pigment-based ink composition when printed on the ink receiving layer of the substrate. Suitable pigment-based inkjet compositions for printing on the print media products of the present invention comprise an insoluble pigment, a dispersant and an aqueous carrier. The pigment-based inkjet composition comprise from about 0.1% to about 10%, more preferably from about 2% to about 6% of an insoluble pigment, from about 0.1% to about 10% of a dispersant, and an aqueous carrier.

A wide variety of organic and inorganic pigments, alone or in combination, may be selected for use in the aqueous inks. The key selection criterion for a pigment is that it must be dispersible in the aqueous medium with the aid of dispersants. The term “pigment”, as used herein, means an insoluble colorant (including organic and inorganic pigments). The selected pigment may be used in dry or wet form.

Suitable pigments include organic and inorganic pigments of a particle size sufficient to permit free flow of the ink through the ink jet printing device, especially at the ejecting nozzles that usually have a diameter ranging from about 0.05 to about 15, preferably from about 0.05 to about 5, and more preferably from about 0.05 to about 0.5, microns. Pigments suitable for use in the present invention include azo pigments, such as azo lakes, insoluble azo pigments, condensed azo pigments, and chelate azo pigments, polycyclic pigments, perylene pigments, anthraquinone pigments, quinacridone pigments, dioxazine pigments, thioindigo pigments, isoindolinone pigments, quinophthalone pigments, and dry lakes. Suitable organic pigments include nitro pigments, nitroso pigments, aniline black and daylight fluorescent pigments. Preferred pigments include carbon black, Pigment Red 122, Pigment Red 202, Pigment Yellow 74, Pigment Yellow 128, Pigment Yellow 138, Pigment Yellow 155, Pigment Blue 15:3 and Pigment Blue 15:4.

The second component of the aqueous ink compositions is the dispersant. Dispersants useful in the aqueous ink compositions are generally not limited and include any of those capable of dispersing pigments. The dispersants typically comprise hydrophobic and hydrophilic polymeric segments. The hydrophobic segment tends to interact with the pigment particle in the ink compositions and the hydrophilic segment tends to be solvated by the aqueous medium thereby dispersing the pigment.

Illustrative examples of the dispersants which may be employed in the ink compositions include random or block copolymers (AB, BAB and ABC block copolymers) known in the art. Preferred AB and BAB block copolymers include those, for example, which comprise hydrophobic and hydrophilic segments derived from acrylic monomers. Another illustrative example of dispersants includes random co-polymers.

A preferred class of dispersants which may be employed in the ink compositions described herein include block and/or graft co- or terpolymers comprising a hydrophilic polymeric segment, and one or two hydrophobic polymeric segment(s) having a hydrolytically stable siloxyl substituent or a hydrophobic amide side chain. A particularly preferred subgroup of these dispersants are graft terpolymers which comprise a hydrophilic polymeric segment (particularly an acrylic or methacrylic acid co- or terpolymer) together with a hydrophobic polymeric segment derived from a polyorganosiloxane as described in U.S. Pat. Nos. 5,719,204 and 5,714,538 both of which are incorporated herein by reference.

The third component of the aqueous ink compositions is the aqueous carrier medium which is generally present at from about 70% to about 99% of the composition. The aqueous carrier medium comprises water (preferably deionized water) and, preferably, at least one water soluble organic solvent. Selection of a suitable carrier mixture depends on the requirements of the specific application involved, such as desired surface tension and viscosity, the selected pigment, the desired drying time of the ink, and tie type of paper onto which the ink will be printed. Representative examples of water soluble organic solvents that may be selected include (1) alcohols, such as methyl alcohol, ethyl alcohol, n-propyl alcohol, isopropyl alcohol, n-butyl alcohol, sec-butyl alcohol, t-butyl alcohol, iso-butyl alcohol, furfuryl alcohol, and tetrahydrofurfuryl alcohol; (2) ketones or ketoalcohols, such as acetone, methyl ethyl ketone and diacetone alcohol; (3) ethers, such as tetrahydrofuran and dioxane; (4) esters, such as ethyl acetate, ethyl lactate, ethylene carbonate and propylene carbonate; (5) polyhydric alcohols, such as ethylene glycol, diethylene glycol, triethylene glycol, propylene glycol, tetraethylene glycol, polyethylene glycol, glycerol, 2-methyl-2,4-pentanediol, 1,2,6-hexanetriol and thiodiglycol; (6) lower alkyl mono- or di-ethers derived from alkylene glycols, such as ethylene glycol monomethyl (or monoethyl) ether, diethylene glycol monomethyl (or monoethyl) ether, propylene glycol monomethyl (or monoethyl) ether, triethylene glycol monomethyl (or monoethyl) ether and diethylene glycol dimethyl (or diethyl) ether; (7) nitrogen-containing cyclic compounds, such as pyrrolidone, N-methyl-2-pyrrolidone, and 1,3-dimethyl-2-imidazoli-dinone; and (8) sulfur-containing compounds, such as dimethyl sulfoxide and tetramethylene sulfone. Other useful organic solvents include lactones and lactams. Mixtures of these solvents may be used in the ink compositions.

The aqueous ink compositions may further comprise a humectant mixture. preferred humectants include, but are not limited to, bis-hydroxy terminated thioethers, lactams, and polyalkylene glycols. The amount of humectant in an ink formulation can range from 0 to 40 weight percent, preferably from 15 to 25 weight percent.

The ink compositions may further comprise surfactants to modify the surface tension of the ink and to control the penetration of the ink into the paper. Such surfactants are included in the ink compositions, and are not a component of the dispersant. Suitable surfactants include, but are not limited to, nonionic, amphoteric and ionic surfactants. Preferred surfactants include, but are not limited to, alkyl sulfate, nonyl phenyl polyethylene glyco, SILWET™ (OSI Sealants, Inc.), TERGITOL™ (Union Carbide) and SURFYNOL™ (Air Products and Chemicals, Inc.).

The ink composition may also comprise a binder. The binder included in the ink compositions of the present invention is generally not limited so long as the binder has an ability to form a film. Typically the binder comprises an emulsion of acrylic resin, methacrylic resin, styrene resin, urethane resin, acrylamide resin, epoxy resin, or a mixture of these resins. The resin is not limited by copolymerization methods and may be, for example, a block copolymer, a random copolymer or the like.

In one embodiment, the binder comprises a latex polymer comprising the monomer unit methyl methacrylate, butylacrylate, and methacrylic acid. In another embodiment, the binder comprises a latex polymer comprising the monomer unit methyl methacrylate, butylacrylate, 2-hydroxyethyl methacrylate, and methacrylic acid. In another embodiment, the binder comprises a latex polymer comprising the monomer unit methyl methacrylate, butyl acrylate, N-hydroxymethyl methacrylamide, and methacrylic acid. In another embodiment, the binder has a molecular weight between 150,000 and 300,000.

In another embodiment, the binder comprises a water-soluble polymer comprising the monomer unit methyl methacrylate, butylacrylate, and methacrylic acid. In this embodiment, the binder has a molecular weight between 2,000 and 20,000

The amount of binder used in the inks is limited by the binder's compatibility with the other components of the ink composition and its ability to reduce smearing of the ink. In an embodiment, the amount of binder included in the ink composition may range from about 0.1 to about 10% by weight. In another embodiment, the amount of binder in the ink composition ranges from about 1 to about 5% by weight.

Other additives, such as biocides, viscosity modifiers, penetrants, anti-kogation agents, anti-curling agents, chelating agents, anti-bleed agents, binders and buffers may be added to the ink composition at their art established levels. A preferred biocide includes, but is not limited to, Proxel™ GXL (Zeneca).

Application of the inkjet inks described above onto the print media products of the present invention can be made by any suitable printing process compatible with the aqueous-based inks, such as flexographic printing, pen plotters, continuous stream inkjet printing, drop-on-demand inkjet printing (including piezoelectric, acoustic, and thermal inkjet processes), or the like. The inkjet ink compositions are extremely useful in the thermal inkjet printing process. The print substrate employed may be any print substrate compatible with aqueous-based inks, including plain papers, such as commercial bond papers; coated papers (or special inkjet papers), such as those available from Hewlett Packard, Kodak, Ilford, Canon, and Xerox Corporation; textiles, special inkjet papers, including silica coated papers and photorealistic inkjet papers; photographic papers; and inkjet transparency materials suitable for aqueous inks or inkjet printing processes.

### EXAMPLES

The following examples are detailed descriptions of methods of preparation and use of the print media products of the present invention. The detailed descriptions fall within the scope of, and serve to exemplify, the more general description set forth above. The examples are presented for illustrative purposes only, and are not intended as a restriction on the scope of the invention.

### Example 1

The pigment to total binder ratio is 2 to 1 and PVA to acrylate is 3 to 1. A coating formulation is made from 20 parts of Cab-O-Sperse PG-001 (Cabot Corp, 30 wt % solid, an anionic fumed silica), 15 parts of precooked partially hydrolyzed polyvinyl alcohol Mowiol 40-88 (Clariant, 15 wt % solid, 88% hydrolysis, 2.34 parts acid functionized styrene acrylate, Joncryl 660 (Johnson Polymer, 32 wt % solid), 0.36 parts surfactant 10G (Arch Chemical, 50 wt % solid), and 14.76 parts DI water. After coating formulation is made, it is applied on a treated polyester film Melinex 534 (DuPont) by a #70 rod and dried in an oven at 90° C. The coated film is printed by Clairborne using YOC/YOP IH inks with and without 1% Joncryl 678 additive. The test shows improved smear.

### Example 2

The pigment to a total binder ratio is 2 to 1 and PVA to acrylate is 1 to 1. A coating formulation is made from 26.7 parts of Cab-O-Sperse PG-001 (Cabot Corp. 30 wt % solid, an anionic fumed silica), 13.35 parts of precooked partially hydrolyzed polyvinyl alcohol Mowiol 40-88 (Clariant, 15 wt % solid, 88% hydrolysis), 6.25 parts acid functionized styrene acrylate, Joncryl 660 (Johnson Polymer, 32 wt % solid), 0.48 parts surfactant 10G (Arch Chemical, 50 wt % solid), and 21.22 parts DI water. After coating formulation is made, it is applied on a treated polyester film Melinex 534 (DuPont) by a #70 rod and dried in an oven at 90° C. The coated film is printed by Clairborne using YOC/YOP IH inks with and without 1% Joncryl 678 additive. The test shows improved smear.

### Comparative Example 1

The pigment to total binder ratio is 2 to 1 and PVA to acrylate is 1 to 0 (without acrylate). A coating formulation is made from 26.7 parts of Cab-O-Sperse PG-001 (Cabot Corp, 30 wt % solid, an anionic fumed silica), 26.7 parts of precooked partially hydrolyzed polyvinyl alcohol Mowiol 40-88 (Clariant, 15 wt % solid, 88 hydrolysis), 0.48 parts surfactant 10G (Arch Chemical, 50 wt % solid), and 16.06 parts DI water. After coating formulation is made, it is applied on a treated polyester film Melinex 534 (DuPont) by a #70 rod and dried in an oven at 90° C. The coated film is printed by Clairborne using YOC/YOP IH inks with and without 1% Joncryl 678 additive. The test shows poor smear result.

### Comparative Example 2

The pigment to total binder ratio is 3 to 1 and PVA to acrylate is 0 to 1 (Without PVA). A coating formulation is made from 40 parts of Cab-O-Sperse PG-001 (Cabot Corp, 30 wt % solid, an anionic fumed silica), 12.5 parts acid functionized styrene acrylate, Joncryl 660 (Johnson Polymer, 32 wt % solid), 0.64 parts surfactant 10G (Arch Chemical, 50 wt % solid), and 12.14 parts DI water. After coating formulation is made, it is applied on a treated polyester film Melinex 534 (DuPont) by a #42 rod and dried in an oven at 90° C. The coated film has many small cracks, which can't be used for printing. This is due to acrylate polymer's poor binding capability.

Table 2 below shows the smear test results of the examples and comparative examples by using Clairborne YOC/YOP IH inks with and without 1% Joncryl 678. The test shows are ranked from 1 to 5. 1 is the best and 5 is the worst. Clear improvement can be seen from examples to comparative examples.

TABLE 2

| | Example 1 | Example 2 | Comparative 1 | Comparative 2 |
|---|---|---|---|---|
| | Silica/Binder: | Silica/Binder: | Silica/Binder: | Silica/Binder: |
| | 2/1 | 2/1 | 2/1 | 3/1 |
| | PVA/Joncryl | PVA/Joncryl | PVA/Joncryl | PVA/Joncryl |
| Time | 660: 3/1 | 660: 1/1 | 660: 1/0 | 660:V 0/1 |

YOC/YOP IH Inks Without 1% Joncryl 678

| | | | | |
|---|---|---|---|---|
| 5 min | 2 | 1 | 4 | Coating |
| | | | | cracked |
| 1 hr | 2 | 1 | 4 | N/A |
| 4 hr | 2 | 1 | 4 | N/A |

YOC/YOP IH Inks With 1% Joncryl 678

| | | | | |
|---|---|---|---|---|
| 1 mm | 4 | 2 | 5 | Coating |
| | | | | cracked |
| 5 min | 2 | 1 | 4 | N/A |
| 1 hr | 1 | 1 | 3 | N/A |

### Smear Test Results of Examples and Comparative Examples

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A print media product comprising:
a substrate; and
at least one ink-receiving layer supported by said substrate, said ink-receiving layer being comprised of a first binder comprised of polyvinyl alcohol, a second binder comprised of acrylate, and a pigment comprised of silica or alumina or mixtures thereof.

2. The print media product of claim 1 wherein said ink-receiving layer is comprised of from about 3% to about 95% by weight of said first binder of polyvinyl alcohol.

3. The print media product of claim 1 wherein said ink-receiving layer is comprised of from about 2% to about 85% by weight of said second binder of acrylate.

4. The print media product of claim 1 wherein said ink-receiving layer is comprised of from about 1% to about 95% by weight of said pigment.

5. The print media product of claim 1 wherein said ink-receiving layer comprises at least one additional pigment besides silica or alumina.

6. The print media product of claim 1 wherein said ink-receiving layer comprises a pigment to binder ratio of from about 1 to about 15 of pigment to total binder.

7. The print media product of claim 1 wherein said ink-receiving layer comprises a first to second binder ratio of from about 0.1 to about 10.

8. The print media product of claim 1 wherein said ink-receiving layer comprises at least one additional binder which is different from said first and second binders.

9. The print media product of claim 1 wherein said substrate comprises at least one additional layer.

10. The print media product of claim 9 wherein said additional layer is located between said substrate and said ink-receiving layer, and wherein said additional layer is comprised of at least one composition selected from the group consisting of a pigment, a binder, and mixtures thereof.

11. The print media product of claim 9 wherein said additional layer is located above said ink-receiving layer, and wherein said additional layer is comprised of at least one ingredient selected from the group consisting of a pigment, a binder, and mixtures thereof.

12. The print media product of claim 1 wherein said print media product further comprises at least one ingredient selected from the group consisting of defoamers, biocides, hardeners and crosslinkers, UV/light stabilizers, buffers, slip agents, pH control compounds, and mixtures thereof.

13. The print media product of claim 2 wherein said first binder of polyvinyl alcohol is partially hydrolyzed.

14. The print media product of claim 3 wherein second binder of acrylate is an emulsion and has a number average molecular weight above 20,000, an acid number of from about 20 to about 350, and a T_{g} of from about −30° C. to 150° C.

15. The print media product of claim 4 wherein said silica pigment is a fumed silica.

16. The print media product of claim 1 wherein said substrate is selected from the group consisting of plain, resin coated, photo base, and film.

17. The print media product of claim 1 wherein the coating thickness of the ink receiving layer on the substrate is from about 5 μm to about 60 μm.

18. The print media product of claim 1 wherein said second binder of acrylate is a styrene acrylate.

19. The print media product of claim 3 wherein said second binder of acrylate is a styrene acrylate.

20. The print media product of claim 14 wherein said second binder of acrylate is a styrene acrylate.
